(19) United States
(12) Patent Application Publication
(10) Pub. No.: US 2021/0276582 A1
(43) Pub. Date: Sep. 9, 2021

(54) WARNING CONTROL DEVICE, WARNING CONTROL METHOD, AND COMPUTER PROGRAM PRODUCT

(71) Applicant: Panasonic Intellectual Property Management Co., Ltd., Osaka (JP)

(72) Inventors: Shuya YAMAMOTO, Osaka Fu (JP); Yoshiteru KAWASAKI, Osaka Fu (JP); Kenichi YADANI, Kyoto Fu (JP); Eiji IRIE, Osaka Fu (JP)

(73) Assignee: Panasonic Intellectual Property Management Co., Ltd., Osaka (JP)

(21) Appl. No.: 17/121,836

(22) Filed: Dec. 15, 2020

(30) Foreign Application Priority Data
Mar. 9, 2020 (JP) 2020-040346

(51) Int. Cl. B60W 50/14; G08G 1/16

(52) U.S. Cl. CPC B60W 50/14; G08G 1/167; B60W 2050/146; G08G 1/162; B60W 2050/143; G08G 1/166

(57) ABSTRACT

A warning control device includes a hardware processor connected to a warning device issuing warning to a driver of a vehicle in which the warning control device is provided. The hardware processor executes a first determination to determine whether the vehicle is traveling in an overtaking prohibited section, and executes a second determination to determine whether the vehicle is attempting an overtaking action. The hardware processor executes a third determination to determine a risk degree of the vehicle on a basis of a result of the first determination and a result of the second determination, and output, to the warning device, a signal for controlling contents of warning to be issued by the warning device, the signal being based on a result of the third determination.

### CROSS-REFERENCE TO RELATED APPLICATIONS

This application is based upon and claims the benefit of priority from Japanese Patent Application No. 2020-040346, filed on Mar. 9, 2020, the entire contents of which are incorporated herein by reference.

### FIELD

The present disclosure relates to a warning control device, a warning control method, and a computer program product.

### BACKGROUND

There are proposed various kinds of driving assist devices for assisting drive by drivers in vehicles. For example, the driving assist device described in Japanese Patent Application Laid-open No. 2016-224712 is configured to issue warning to a driver by a warning device in response to detecting the overtaking of a subject vehicle.

In the driving assist device described in Japanese Patent Application Laid-open No. 2016-224712, warning is issued when the subject vehicle is attempting an overtaking action. However, it does not disclose the change of warning contents for the driver based on the risk degree of the subject vehicle. Thus, it is difficult to enable the driver to recognize the risk degree.

### SUMMARY

A warning control device according to one aspect of the present disclosure includes a hardware processor connected to a warning device issuing warning to a driver of a vehicle in which the warning control device is provided. The hardware processor is configured to: execute a first determination to determine whether the vehicle is traveling in an overtaking prohibited section; execute a second determination to determine whether the vehicle is attempting an overtaking action; execute a third determination to determine a risk degree of the vehicle on a basis of a result of the first determination and a result of the second determination; and output, to the warning device, a signal for controlling contents of warning to be issued by the warning device, the signal being based on a result of the third determination.

### BRIEF DESCRIPTION OF THE DRAWINGS

FIG. 1 is a block diagram illustrating an example a warning system according to an embodiment;

FIG. 2 is a block diagram illustrating an example of the functional configuration of a warning control device according to the embodiment;

FIG. 3 is a flowchart for explaining warning control processing performed by the warning system according to the embodiment;

FIG. 4 is a diagram illustrating examples that the color of warning indication on a display is changed in accordance with individual risk degrees;

FIG. 5 is a diagram illustrating examples that the representation form of warning indication on a display is changed in accordance with individual risk degrees;

FIG. 6 is a diagram illustrating examples that the size of warning indication on a display is changed in accordance with individual risk degrees;

FIG. 7 is a diagram illustrating examples that the color of warning indication on a meter display is changed in accordance with individual risk degrees; and

FIG. 8 is a flowchart for explaining warning control processing performed by a warning system according to a modification of the embodiment.

### DETAILED DESCRIPTION

### Embodiment

The following will specifically describe an embodiment while appropriately refereeing to the enclosed drawings. However, the unnecessarily detailed description may be omitted. For example, the following may omit the detailed description of already well-known facts and the repeated description of substantially the same components. This avoids unnecessarily abundant description and facilitates understanding of persons skilled in the art.

Note that the enclosed drawings and the following description are provided to allow persons skilled in the art to sufficiently understand the present disclosure, and do not intend to restrict the subject matter described in the claims.

Moreover, in the following description, “driving rules” are described with a premise of Japanese traffic regulations at the time of application.

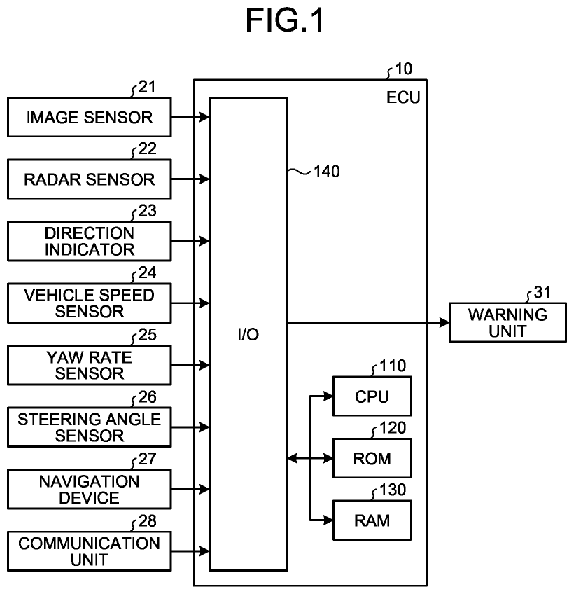

The following will describe the embodiment of the disclosure with reference to FIG. 1 to FIG. 7.

### Configuration

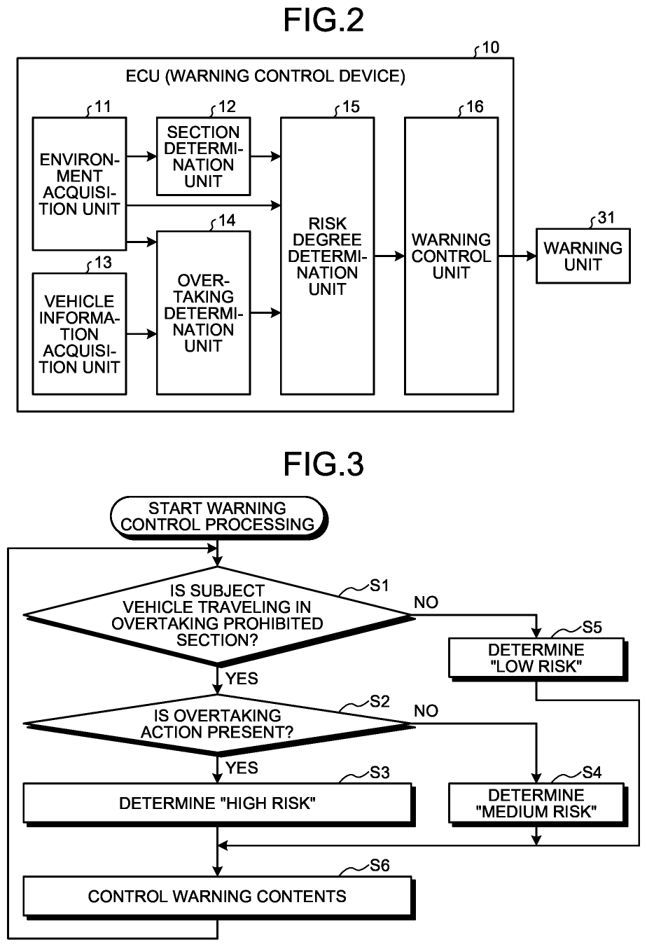

The following will first describe the configuration of a warning system including a warning control device according to the embodiment with reference to FIG. 1 and FIG. 2.

FIG. 1 is a block diagram illustrating an embodiment of a warning system according to the embodiment. The warning system of the embodiment includes an image sensor 21, a radar sensor 22, a direction indicator 23, a vehicle speed sensor 24, a yaw rate sensor 25, a steering angle sensor 26, a navigation device 27, a communication unit 28, an electronic control unit (ECU) 10, and a warning unit 31.

Note that a vehicle provided with the warning system may be referred to as a subject vehicle.

In FIG. 1, the image sensor 21, the radar sensor 22, the direction indicator 23, the vehicle speed sensor 24, the yaw rate sensor 25, the steering angle sensor 26, the navigation device 27, and the communication unit 28 are connected to the ECU 10 that is a warning control device. Each of these components inputs detection signals and various information to the ECU 10.

The image sensor 21 is an in-vehicle camera, and formed by a charge-coupled device (CCD) camera, a complementary metal-oxide-semiconductor (CMOS) image sensor, a near infrared camera, and the like. The image sensor 21 captures images of surrounding environments including travelling roads of the subject vehicle. The image sensor 21 then generates image data representing the captured images, and successively outputs the image data to the ECU 10. The image sensor 21 is provided near, for example, the upper end of the front glass of the subject vehicle and captures an image of an area expanding with a given angle toward the front side of the subject vehicle. Note that the image sensor 21 may be a monocular camera or a stereo camera.

The radar sensor 22 is a device that transmits electromagnetic waves as transmission waves and receives the reflected waves so as to detect an object. The radar sensor 22 is formed by a millimeter-wave radar or a laser radar, for example. The radar sensor 22 is attached on the front part of the subject vehicle, and scans, with radar signals, an area expanding over a range with a given angle toward the front side of the subject vehicle with an optical axis as a center. Then, the radar sensor 22 generates measurement data on the basis of time from the transmission of electromagnetic waves toward the front side of the subject vehicle to the reception of reflected waves, and successively outputs the measurement data to the ECU 10. Such measurement data contains information related to a direction where an object exists, a distance to the object, and a relative speed.

The direction indicator 23 is a device that displays a travelling direction of the subject vehicle to the outside of the vehicle. The direction indicator 23 includes an operation lever operated by the driver in the left turn position, the neutral position, or the right turn position. The direction indicator 23 outputs, to the ECU 10, a turn signal being an operation signal corresponding to one of the positions of the operation lever.

The vehicle speed sensor 24 is provided on a rotation axis conveying power to the wheels of the subject vehicle, and outputs detection signals in accordance with a vehicle speed. The yaw rate sensor 25 includes a vibrator such as tuning fork, for example, and detects distortion generated in the vibrator on the basis of yaw moment of the subject vehicle so as to detect a yaw rate of the subject vehicle. The steering angle sensor 26 detects an operation angle, that is, a steering angle of the handle of the subject vehicle. These sensors 24 to 26 detect a travelling state, that is, a behavior of the subject vehicle. The sensors 24 to 26 supply the detected travelling state and the like of the subject vehicle to the ECU 10.

The navigation device 27 acquires map information including information representing the terrain, road shapes, and the like in coordinates of the absolute coordinate system. The map information acquired by the navigation device 27 may be stored in a map information storage medium provided in the subject vehicle, or obtained by communication with an external device. In the case of the embodiment, the navigation device 27 acquires route information from a current position to a destination. The navigation device 27 outputs map information and route information to the ECU 10. Moreover, the navigation device 27 may display such information on a car navigation system, a head-up display, and the like, as images.

For example, in a case of detecting that the subject vehicle has approached, within a predetermined distance, to an intersection where the subject vehicle is to turn right or left, the navigation device 27 outputs, to the ECU 10, such information and information on the direction to which the subject vehicle should turn right or left.

The communication unit 28 communicates with a communication unit provided in a vehicle other than the subject vehicle. The communication unit 28 comprises a beacon and the like. The communication unit 28 may be provided near, for example, the sheet or at another position as long as the position allows favorable communication. The communication unit 28 includes a reception unit that receives vehicle information from other vehicles and a transmission unit that transmits vehicle information on the subject vehicle (subject vehicle information). The vehicle information received at the reception unit of the communication unit 28 is transmitted to the ECU 10, while the subject vehicle information acquired at the ECU 10 is transmitted through the transmission unit. Here, the vehicle information contains vehicle identification information, vehicle position information, and the like. The identification information is a vehicle-specific ID, and the position information is coordinates indicating a current position of the vehicle. In addition, the vehicle information contains a vehicle speed and the like.

The ECU 10 is a computer including a central processing unit (CPU) 110 as a hardware processor, a read only memory (ROM) 120, a random access memory (RAM) 130, an input/output port (I/O) 140, and the like.

The image sensor 21, the radar sensor 22, the direction indicator 23, the vehicle speed sensor 24, the yaw rate sensor 25, the steering angle sensor 26, the navigation device 27, and the communication unit 28 are connected to the I/O 140 of the ECU 10. Each of these components input detection signals and various kinds of information to the I/O 140. The I/O 140 gives the input detection signals and various kinds of information to the CPU 110 and the RAM 130. Moreover, the I/O 140 outputs, to the warning unit 31, control signals and the like from the CPU 110.

In the ECU 10, the CPU 110 executes a computer program installed in the ROM 120 to control the warning action by the warning unit 31 to a driver. The computer program may be preliminarily recorded in the ROM 120 of the ECU 10, or may be provided through an electric communications line such as the Internet. The computer program may be recorded in a non-transitory computer-readable recording medium such as various kinds of discs or a recording medium such as a memory card, and be provided as a computer program product to a user.

FIG. 2 is a block diagram illustrating an example of the functional configuration of the warning control device according to the embodiment. The ECU 10 includes, as the functional configuration, an environment acquisition unit 11, a section determination unit 12, a vehicle information acquisition unit 13, an overtaking determination unit 14, a risk degree determination unit 15, and a warning control unit 16.

The environment acquisition unit 11 acquires the surrounding state of the subject vehicle. To be more specific, the environment acquisition unit 11 acquires the surrounding state of the subject vehicle on the basis of information supplied from the image sensor 21, the radar sensor 22, and the like provided in the subject vehicle. The surrounding state of the subject vehicle acquired by the environment acquisition unit 11 includes the presence and absence of a vehicle other than the subject vehicle, a position, a moving direction, a relative speed to the subject vehicle, and attributes of such a vehicle, and the like. Moreover, when the vehicle-to-vehicle communication is possible with a vehicle other than the subject vehicle, the environment acquisition unit 11 acquires vehicle information on that vehicle through the communication unit 28. The environment acquisition unit 11 supplies the acquired information related to the surrounding state of the subject vehicle to the section determination unit 12, the overtaking determination unit 14, and the risk degree determination unit 15.

The section determination unit 12 determines whether the subject vehicle is travelling in an overtaking prohibited section (a first determination), on the basis of information acquired by the environment acquisition unit 11. The overtaking prohibited section is a section defined by driving rules for driving vehicles defined in a corresponding country. The overtaking prohibited section includes, for example, a place where the overtaking is prohibited by signs, the vicinity of corners of a road, an intersection, and an area within 30 m from the intersection, and the like. The section determination unit 12 determines whether the subject vehicle is travelling in the overtaking prohibited section, on the basis of, for example, image data of road signs, intersections, and the like that are captured by the image sensor 21. Note that the section determination unit 12 may determine whether the subject vehicle is travelling in the overtaking prohibited section, on the basis of information on overtaking prohibited sections acquired by the navigation device 27. The section determination unit 12 notifies the risk degree determination unit 15 of the determination result.

The vehicle information acquisition unit 13 acquires, from the direction indicator 23, vehicle information representing various states of the subject vehicle, the vehicle speed sensor 24, the yaw rate sensor 25, the steering angle sensor 26, the navigation device 27, and the like that are provided in the subject vehicle. To be more specific, the vehicle information acquisition unit 13 acquires operation signals related to lane change from the direction indicator 23, signals related to the vehicle speed of the subject vehicle from the vehicle speed sensor 24, signals related to the yaw angle and steering angle from the yaw rate sensor 25 and the steering angle sensor 26, respectively, and the information related to a current position of the subject vehicle from the navigation device 27. The vehicle information acquisition unit 13 supplies the acquired vehicle information to the overtaking determination unit 14.

The overtaking determination unit 14 determines whether the subject vehicle is attempting an overtaking action (a second determination). The overtaking action refers to an action enabling the subject vehicle to overtake a preceding vehicle. To be more specific, in response to detecting that the subject vehicle is attempting to change the lane and a preceding vehicle to be overtaken exists, on the basis of pieces of information supplied by the environment acquisition unit 11 and the vehicle information acquisition unit 13, the overtaking determination unit 14 determines that the subject vehicle is attempting an overtaking action. The overtaking determination unit 14 notifies the risk degree determination unit 15 of the determination result.

Note that the overtaking determination unit 14 determines that the subject vehicle is attempting to change the lane, on the basis of vehicle information acquired by the vehicle information acquisition unit 13. This determination includes determination of the presence and absence of an initial action of overtaking. To be more specific, the overtaking determination unit 14 determines whether a turn signal from the direction indicator 23 has issued. When it is determined that the turn signal has issued, the overtaking determination unit 14 determines that the initial action of overtaking arises.

Moreover, the overtaking determination unit 14 determines that a preceding vehicle to be overtaken exists, on the basis of information supplied from the environment acquisition unit 11. To be more specific, the overtaking determination unit 14 determines the presence and absence, a position, a moving direction, and attributes of such a preceding vehicle, a relative speed to the preceding vehicle to the subject vehicle, and a distance between the preceding vehicle and the subject vehicle. Then, when the speed of the subject vehicle is a given speed (30 km/h, for example) or higher, the distance between the preceding vehicle and the subject vehicle is a given distance (70 m, for example) or shorter, and the relative speed of the subject vehicle to the preceding vehicle is within a given range, the overtaking determination unit 14 determines that the preceding vehicle to be overtaken exists.

The risk degree determination unit 15 determines a current risk degree of the subject vehicle (a third determination), on the basis of information supplied from the environment acquisition unit 11, the section determination unit 12, and the overtaking determination unit 14. The “risk degree” represents the probability that an event causing a driver to feel dangerous occurs during driving. Such an event includes collision of vehicles, collision of the subject vehicle against a structure such as a guardrail, an accident of contact and the like between a pedestrian and the subject vehicle, or an event that is not an accident but may lead to an accident with high probability, for example. The risk degree determined by the risk degree determination unit 15 includes, for example, three stages of “low risk”, “medium risk”, and “high risk”. The details of this determination will be described later. The risk degree determination unit 15 notifies the warning control unit 16 of a determination result.

The warning control unit 16 controls the later-described warning unit 31 on the basis of the risk degree provided by the risk degree determination unit 15. To be more specific, when the risk degree determination unit 15 has determined that the risk degree of the subject vehicle is “low risk”, “medium risk”, or “high risk”, the warning control unit 16 outputs, to the warning unit 31, a signal for instructing the warning unit 31 to perform a warning action corresponding to the determined risk degree.

The warning unit 31 (a warning device) is connected to the warning control unit 16. The warning unit 31 notifies a driver of the fact that, for example, the dangerous situation has occurred on the subject vehicle or some dangerous actions have been performed by the subject vehicle. The warning unit 31 includes at least one of the display means such as a display device, an instrument panel, and a car navigation system, the sound output means such as a speaker, an alarm, and a bell, the light emitting means such as a light emitting diode (LED) and a lamp in a vehicle, the vibrating means such as a vibrator provided at a steering wheel, an acceleration pedal, a brake pedal, a seat, a head rest, a seat belt, or the like, and the means for giving reaction force to the driving operation by the above-described means. To warn a driver, the warning control unit 16 controls at least one warning unit 31. Note that the warning control unit 16 may give warning by linking a plurality of warning units 31. For example, the steering wheel may be vibrated while sound is output to the speaker.

### Warning control Processing

The following will describe the warning control processing performed by the ECU 10 with reference to FIG. 3 to FIG. 7.

FIG. 3 is a flowchart for explaining warning control processing performed by the warning system according to the embodiment. This processing is repeatedly performed by the ECU 10 in a predetermined cycle during travelling of the subject vehicle.

At Step S1, the section determination unit 12 determines whether the subject vehicle is travelling in an overtaking prohibited section. In the case of Yes at Step S1, the section determination unit 12 notifies the risk degree determination unit 15 of the fact that the subject vehicle is travelling in the overtaking prohibited section, and the processing advances to Step S2. In the case of No at Step S1, the section determination unit 12 notifies the risk degree determination unit 15 of the fact that the subject vehicle is not travelling in the overtaking prohibited section, and the processing advances to Step S5.

At Step S2, the overtaking determination unit 14 determines whether the subject vehicle is attempting an overtaking action. For example, the overtaking determination unit 14 acquires information of the presence and absence of an initial action of overtaking from the vehicle information acquisition unit 13, and determines whether the subject vehicle is attempting to change the lane. Moreover, the overtaking determination unit 14 acquires information of the presence and absence of a preceding vehicle from the environment acquisition unit 11, and determines whether a preceding vehicle to be overtaken exists. When the subject vehicle is attempting to change the lane and a preceding vehicle to be overtaken exists, the overtaking determination unit 14 determines that the subject vehicle is attempting an overtaking action.

In the case of Yes at Step S2, the overtaking determination unit 14 notifies the risk degree determination unit 15 of the fact that the subject vehicle is attempting an overtaking action, and the processing advances to Step S3. In the case of No at Step S2, the overtaking determination unit 14 notifies the risk degree determination unit of the fact that the subject vehicle is not attempting an overtaking action, and the processing advances to Step S4.

At Step S3 (in the cases of Yes at Step S1 and Yes at Step S2), the risk degree determination unit 15 determines “high risk” on the basis of the determination results made by the section determination unit 12 and the overtaking determination unit 14 that the subject vehicle is travelling in an overtaking prohibited section and is attempting an overtaking action. The risk degree determination unit 15 supplies the determined risk degree to the warning control unit 16, and the processing advances to Step S6.

At Step S4 (in the case of Yes at Step S1 and No at Step S2), the risk degree determination unit 15 determines “medium risk” on the basis of the determination results made by the section determination unit 12 and the overtaking determination unit 14 that the subject vehicle is travelling in an overtaking prohibited section and is not attempting an overtaking action. The risk degree determination unit 15 supplies the determined risk degree to the warning control unit 16, and the processing advances to Step S6.

At Step S5 (in the case of No at Step S1), the risk degree determination unit 15 determines “low risk” on the basis of the determination result made by the section determination unit 12 that the subject vehicle is not travelling in an overtaking prohibited section. The risk degree determination unit 15 supplies the determined risk degree to the warning control unit 16, and the processing advances to Step S6.

At Step S6, the warning control unit 16 controls the warning unit 31, on the basis of the risk degree of the subject vehicle supplied from the risk degree determination unit 15, and then warns the driver. Specifically, the warning control unit 16 outputs, to the warning unit 31, a signal for controlling contents of warning to be issued by the warning unit 31. Here, the warning control unit 16 may select at least one subject to be controlled, from among the warning unit 31 such as the display means, the sound output means, the light emitting means, and the vibrating means. The following specifically describes the methods of controlling the warning unit 31 by the warning control unit 16 in each case that the warning unit 31 is the display means, the sound output means, the vibrating means, or the light emitting means.

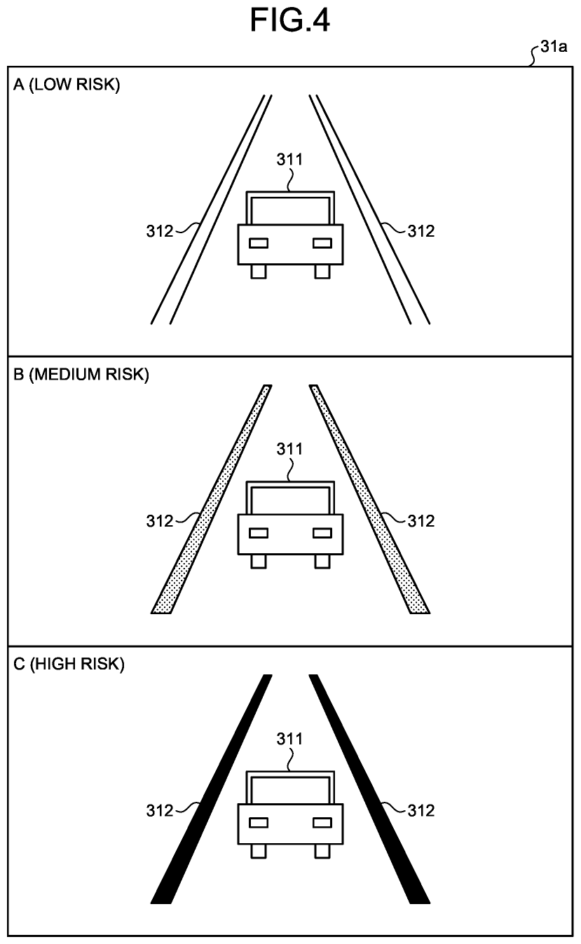

In a case where the display means (device) is used as the warning unit 31, the warning control unit 16 controls the display means by outputting, to the display means, a signal for instructing to change the form of warning indication displayed on the display means in accordance with the risk degree. For example, the warning control unit 16 controls a display 31a that is one example of the display means. FIG. 4 is a diagram illustrating examples that the color of warning indication displayed on the display 31a is changed in accordance with individual risk degrees. In each example illustrated in FIG. 4, an image 312 of a division line separating traffic lanes is used as warning indication. The display 31a of FIG. 4 displays an image 311 representing a vehicle and the image 312 of the division line. When the risk degree determination unit 15 has determined that the risk degree is “low risk”, the warning control unit 16 outputs, to the display 31a, a signal for instructing the display 31a to display the image 312 in blue, as illustrated in an example A of FIG. 4. After that, when the risk degree is changed from “low risk” to “medium risk”, the warning control unit 16 outputs, to the display 31a, a signal for instructing the display 31a to change the color of the image 312 from blue to yellow, as illustrated in an example B of FIG. 4. After that, when the risk degree is changed from “medium risk” to “high risk”, the warning control unit 16 outputs, to the display 31a, a signal for instructing the display 31a to change the color of the image 312 from yellow to red, as illustrated in an example C of FIG. 4. Moreover, when the state of “low risk”, “mediums risk”, or “high risk” is continued, the warning control unit 16 controls the display 31a to continue the display in blue, yellow, or red. When the risk degree is changed from “high risk” to “medium risk”, the warning control unit 16 controls the display 31a to change the color of the image 312 from red to yellow, and controls the display 31a to change the color of the image 312 to blue when the risk degree is changed to “low risk”.

The control by the warning control unit 16 is not limited to the change in color of the image 312. For example, the warning control unit 16 may control the display means to continuously display the image 312 when the risk degree is “low risk”, blinkingly display the image 312 when the risk degree is changed to “medium risk”, and shorten the blinking cycle (blink faster) as compared to in the case of “medium risk” when the risk degree is changed to “high risk”.

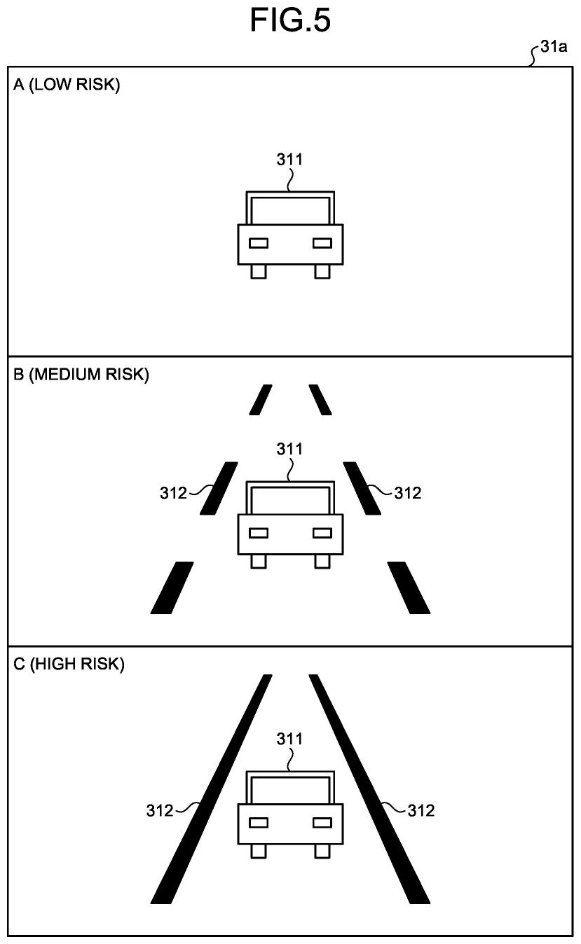

Alternatively, the representation form of the image 312 may be changed to solid lines, broken lines, or the like in accordance with the risk degree. FIG. 5 is a diagram illustrating examples that the representation form of warning indication displayed on the display 31a is changed in accordance with individual risk degrees. Also in the example illustrated in FIG. 5, the image 312 of a division line is used as warning indication, similarly to the example of FIG. 4. When the risk degree determination unit 15 has determined that the risk degree is “low risk”, the warning control unit 16 controls the display 31a not to display the image 312, as illustrated in an example A of FIG. 5. When the risk degree determination unit has determined that the risk degree is “medium risk”, the warning control unit 16 controls the display 31a to display the image 312 with broken lines, as illustrated in an example B of FIG. 5. When the risk degree determination unit has determined that the risk degree is “high risk”, the warning control unit 16 controls the display 31a to display the image 312 with solid lines, as illustrated in an example C of FIG. 5.

As described above, the display form of the image 312 of the division line is changed in accordance with the risk degree. Therefore, the driver is able to easily recognize the risk of changing the line, enabling the driver to efficiently recognize the risk of overtaking.

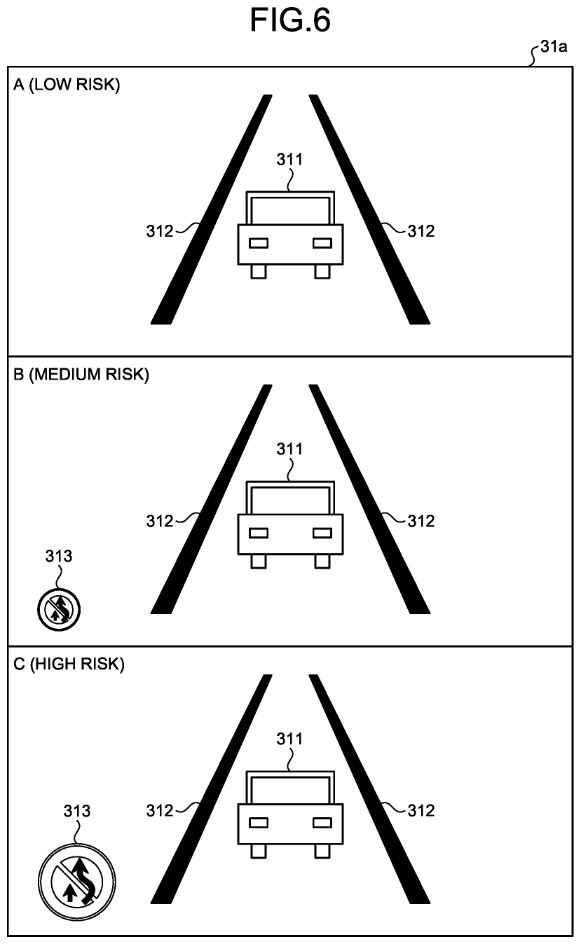

Moreover, the warning control unit 16 may control the display 31a to change the size of warning indication displayed on the display 31a in accordance with the risk degree. FIG. 6 is a diagram illustrating examples that the size of warning indication displayed on the display 31a is changed in accordance with individual risk degrees. In each example illustrated in FIG. 6, an image 313 representing prohibition of overtaking is used as warning indication. When the risk degree determination unit 15 has determined that the risk degree is “low risk”, the warning control unit 16 outputs, to the display 31a, a signal for instructing the display 31a not to display the image 313, as illustrated in an example A of FIG. 6. When the risk degree determination unit 15 has determined that the risk degree is “medium risk”, the warning control unit 16 outputs, to the display 31a, a signal for instructing the display 31a to display the image 313, as illustrated in an example B of FIG. 6. When the risk degree determination unit 15 has determined that the risk degree is “high risk”, the warning control unit 16 outputs, to the display 31a, a signal for instructing the display 31a to display the image 313 more largely than that in “medium risk”, as illustrated in an example C of FIG. 6.

Alternatively, the warning control unit 16 may add an animation in the warning indication to notify the driver of the change of the risk degree. For example, in the examples of FIG. 4 to FIG. 6, when the form of warning indication is changed in accordance with the risk degree, the form of warning indication may be changed with an animation. Moreover, when the risk degree is high, the form of warning indication may be changed continuously with an animation.

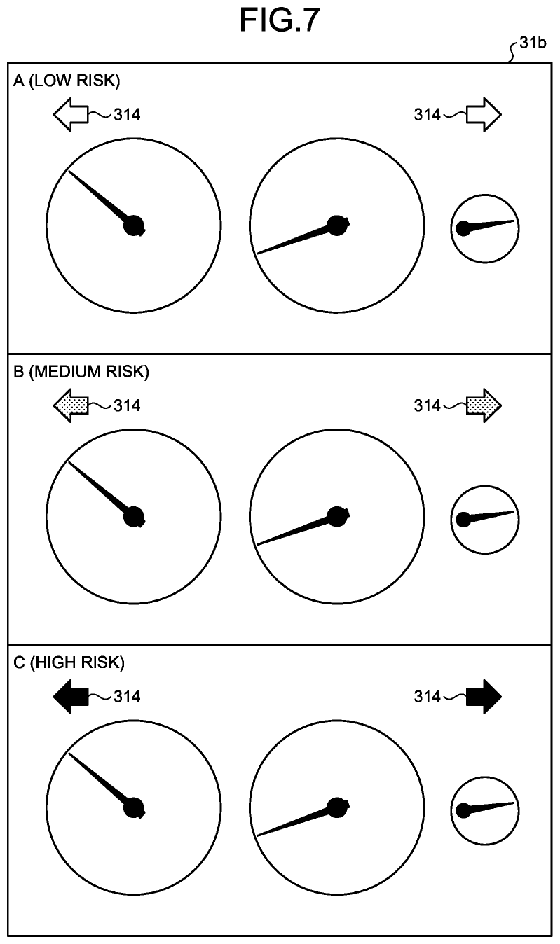

Alternatively, the warning control unit 16 may control a meter display 31b that is one example of the display means. FIG. 7 is a diagram illustrating examples that the color of warning indication on the meter display 31b is changed in accordance with individual risk degrees. In the examples illustrated in FIG. 7, an image of an indication 314 related to direction instruction based on turn signals from the direction indicator 23 is used as warning indication. When the turn signals have issued and the risk degree determination unit 15 has determined that the risk degree is “low risk”, the warning control unit 16 outputs, to the meter display 31b, a signal for instructing the meter display 31b to display an image of the indication 314 in blue, as illustrated in an example A of FIG. 7. When the risk degree determination unit 15 has determined that the risk degree is “medium risk”, the warning control unit 16 outputs, to the meter display 31b, a signal for instructing the meter display 31b to display an image of the indication 314 in yellow, as illustrated in an example B of FIG. 7. When the risk degree determination unit 15 has determined that the risk degree is “high risk”, the warning control unit 16 outputs, to the meter display 31b, a signal for instructing the meter display 31b to display an image of the indication 314 in red, as illustrated in an example C of FIG. 7.

In a case where the sound output means (device) is used as the warning unit 31, the warning control unit 16 controls the sound output means by outputting, to the sound output means, a signal for instructing to change the volume of warning sound in accordance with the risk degree. To be more specific, the warning control unit 16 controls the sound output means not to output warning sound when the risk degree is “low risk”, controls the sound output means to output warning sound when the risk degree is “medium risk”, and controls the sound output means to output warning sound with the higher degree of warning than in the case of “medium risk” when the risk degree is “high risk”. For the higher degree of warning, there may be adopted the way of outputting warning sound with a larger volume than in the case of “medium risk”, for example. Furthermore, in such a case, the warning volume may be increased, and a volume of music or radio being played in the subject vehicle may be lowered so that the driver can easily recognize the warning sound. Moreover, the warning control unit 16 may controls the warning unit 31 so as to output warning sound only during a certain period of time from the time when the risk degree is increased and not to output warning sound when the same state of the risk degree is continued, instead of continuously outputting warning sound in accordance with the risk degree.

In a case where the vibrating means (device) is used as the warning unit 31, the warning control unit 16 controls thee vibrating means by outputting a signal for instructing the vibrating means not to operate when the risk degree is “low risk”, outputting a signal for instructing the vibrating means to intermittently generate vibration when the risk degree is “medium risk”, and outputting a signal for instructing the vibrating means to continuously generate vibration when the risk degree is “high risk”. Moreover, the warning control unit 16 may control the vibrating means to generate vibration only for a certain period of time from when the risk degree rises, and not to generate vibration when the same state of the risk degree is continued.

In a case where the light emitting means (device) is used as the warning unit 31, the warning control unit 16 controls the light emitting means by outputting a signal for instructing the light emitting means to emit light in a normal color (white and the like) or turn off light when the risk degree is “low risk”. After that, when the risk degree is changed to “medium risk”, the warning control unit 16 controls the light emitting means to continuously emit light in red. After that, when the risk degree is changed to “high risk”, the warning control unit 16 controls the light emitting means to blinkingly emit light in red. Moreover, the warning control unit 16 may change the brightness of light emitting means in accordance with the risk degree.

Moreover, the warning control unit 16 may perform a control so that the driver will be warned by combination of a plurality of the above-described warning units 31. The following describes an example that the warning control unit 16 controls a display device that is one example of the display means and a speaker that is one example of the sounds output means. The warning control unit 16 controls the display device to display warning indication in blue when the risk degree is determined “low risk”, and controls the speaker not to output warning sound. When the risk degree is changed from “low risk” to “medium risk”, the warning control unit 16 controls the display device to change the warning indication from blue to yellow and controls the speaker to output warning sound. When the risk degree is changed from “medium risk” to “high risk”, the warning control unit 16 controls the display device to change the warning indication from yellow to red and controls the speaker to output warning sound with a larger volume, for example, so as to be warning sound with the higher degree of warning. When the risk degree is changed from “high risk” to “medium risk”, the warning control unit 16 changes the warning indication from red to yellow, and changes it to blue when the risk degree is changed to “low risk”. The speaker is controlled to output warning sound when the risk degree is increased from “low risk” to “medium risk” or from “medium risk” to “high risk”, and is controlled not to output warning sound when the state of “medium risk” or “high risk” is continued or when the risk degree is lowered.

After Step S6, the processing returns to Step S1, and the processing following Step S1 is performed.

### Modification

In the above-described embodiment, the risk degree is determined based on the determination (the section determination unit 12) of whether the subject vehicle is travelling in an overtaking prohibited section and the determination (the overtaking determination unit 14) of whether the subject vehicle is attempting an overtaking action. In the following modification, the risk degree is determined based on another kind of information.

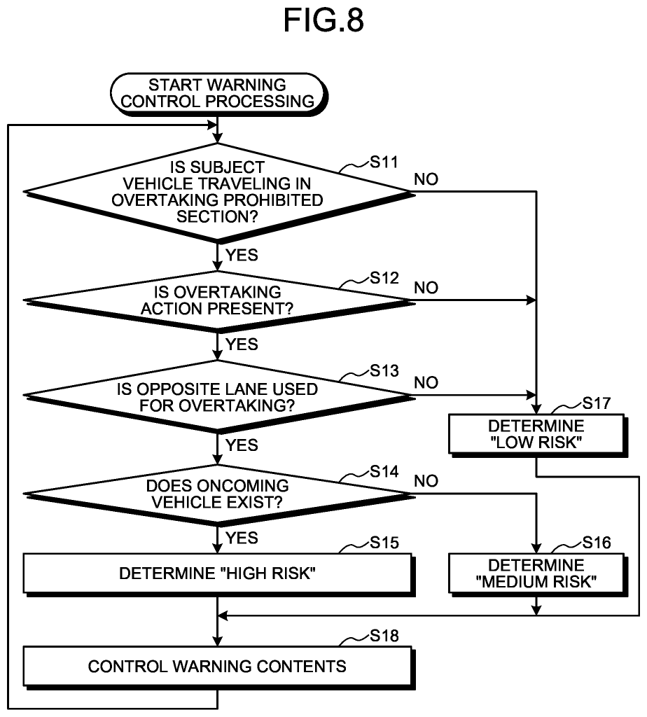

FIG. 8 is a flowchart for explaining warning control processing performed by a warning system according to a modification of the embodiment. This processing is repeatedly performed by the ECU 10 in a predetermined cycle during travelling of the subject vehicle.

At Step S11, the same determination and notification as the above-described embodiment are made. In the case of Yes, the processing advances to Step S12, while in the case of No, the processing advances to Step S17.

At Step S2, the same determination and notification as those in the above-described embodiment are made. In the case of Yes, the processing advances to Step S13, while in the case of No, the processing advances to Step S17.

At Step S13, the risk degree determination unit 15 determines whether the lane to be used by the subject vehicle for overtaking is an opposite lane. Here, the risk degree determination unit 15 performs this determination on the basis of information supplied from the environment acquisition unit 11. In the case of Yes at Step S13, the processing advances to Step S14. In the case of No at Step S13, the processing advances to Step S17.

At Step S14, the risk degree determination unit 15 determines whether an oncoming vehicle exists in a given distance (150 m, for example) from the subject vehicle. Here, the risk degree determination unit 15 performs this determination on the basis of information supplied from the environment acquisition unit 11. In the case of Yes at Step S14, the processing advances to Step S15. In the case of No at Step S14, the processing advances to Step S16.

At Step S15 (in the case of Yes at all of Step S 11 to Step S14), the risk degree determination unit 15 determines “high risk” on the basis of the determination results by the overtaking determination unit 14 and the risk degree determination unit 15 that the subject vehicle is travelling in an overtaking prohibited section and is attempting an overtaking action, the lane to be used by the subject vehicle for overtaking is an opposite lane, and the oncoming vehicle exists within a given distance. The risk degree determination unit 15 supplies the determined risk degree to the warning control unit 16, and the processing advances to Step S18.

At Step S16 (in the case of Yes at Step S11 to Step S13 and No at Step S14), the risk degree determination unit 15 determines “medium risk” on the basis of the determination results by the overtaking determination unit 14 and the risk degree determination unit 15 that the subject vehicle is travelling in an overtaking prohibited section and is attempting an overtaking action, the lane to be used by the subject vehicle for overtaking is an opposite lane, and the oncoming vehicle does not exist within a given distance. The risk degree determination unit 15 supplies the determined risk degree to the warning control unit 16, and the processing advances to Step S18.

At Step S17 (in the case of No at any one of Step S11 to Step S13), the risk degree determination unit 15 determines “low risk” on the basis of the determination result by the section determination unit 12 that the subject vehicle is not travelling in an overtaking prohibited section, the determination result by the overtaking determination unit 14 that the subject vehicle is not attempting an overtaking action, or the determination result by the risk degree determination unit 15 that the lane to be used by the subject vehicle for overtaking is not an opposite lane. The risk degree determination unit 15 supplies the determined risk degree to the warning control unit 16, and the processing advances to Step S8.

At Step S18, the warning control unit 16 controls the warning unit 31 on the basis of the risk degree of the subject vehicle supplied from the risk degree determination unit 15, and then warns the driver. The detail of the warning procedures is the same as that in the above-described embodiment.

After Step S18, the processing returns to Step S11, and the processing following Step S11 is performed.

### Other Modifications

In the above-described embodiment and modification, the risk degree determination unit 15 determines the risk degree in three stages of “low risk”, “medium risk”, and “high risk”. Alternatively, the risk degree determination unit 15 may determine the risk degree in two stages or four or more stages. For example, in the modification of FIG. 8, the “low risk” may be divided into two stages of “risk degree 1” and “risk degree 2” in this order from the lower risk degree for determination of the risk degree. In this case, the risk degree determination unit 15 determines “risk degree 1” when the determination is No at Step S11 or No at Step S12, and determines “risk degree 2” when the determination is No at Step S13 because the determination is Yes at both Step S11 and Step S12. In this manner, the risk degree is determined in four stages including the cases of “medium risk” and “high risk”.

Furthermore, the order of the steps in the flowcharts in FIG. 3 and FIG. 8 is not limited thereto. For example, in the modification of FIG. 8, the risk degree determination unit 15 may determine whether an oncoming vehicle exists within a given distance even when it is determined that the lane to be used by the subject vehicle for overtaking is not an opposite lane (No at Step S13), and determine the risk degree. Moreover, the steps in the embodiment and the modification of FIG. 3 and FIG. 8 may be partially omitted for implementation. For example, in the modification of FIG. 8, the section determination unit 12 may not determine whether the subject vehicle is travelling in an overtaking prohibited section (Step S11), and the warning control processing may be started from the determination by the overtaking determination unit 14 of whether the subject vehicle is attempting an overtaking action (Step S12).

Furthermore, the risk degree may be determined by other conditions, instead of the conditions used for determination of the risk degree in the above-described embodiment and modification, or in addition thereto. For example, it is possible to determine that the risk degree is high when the preceding vehicle travels in a meandering manner or when the preceding vehicle repeats sudden braking or sudden starting.

Moreover, when the risk degree determined by the risk degree determination unit 15 is lower than a given risk degree, driver's attention may be called in accordance with the risk degree. Here, to call driver's attention indicates notification given to the driver more moderately than in the case of warning. For example, when the warning unit 31 performs warning by the display means, the driver's attention is called by notification using a smaller image than in the case of warning, and when by the sound output means, the driver's attention is called by emitting smaller sound than in the case of warning.

In the above-described embodiment, the presence and absence of the initial action of overtaking is determined by whether the turn signal has been issued. It may be determined, alternatively or in addition to this, on the basis of the change of a steering angle or the change of yaw signals.

The above-described embodiment has been described with the premise of the Japanese traffic regulations at the time of application. However, even though the traffic regulations and the like are changed depending on the age and country, various changes may be made on the basis of the technical ideas of the present invention so as to adapt thereto.

Furthermore, the embodiment of the present disclosure is not limited to the above-described embodiment, and may be modified variously in a range not departing from the gist of the present disclosure.

### Summary

As is clear from the above-described embodiment, the present disclosure includes the following aspects. In the following, the reference symbols are represented with parentheses only to clarify the correspondence with the embodiment.

The warning control device (10) of the first aspect includes a hardware processor (110) connected to a warning device (31) issuing warning to a driver of a vehicle in which the warning control device is provided. The hardware processor is configured to: execute a first determination (51) to determine whether the vehicle is traveling in an overtaking prohibited section; execute a second determination (S2) to determine whether the vehicle is attempting an overtaking action; execute a third determination (S3-S5) to determine a risk degree of the vehicle on a basis of a result of the first determination and a result of the second determination; and output (S6), to the warning device, a signal for controlling contents of warning to be issued by the warning device, the signal being based on a result of the third determination. According to the first aspect, it is possible to change the warning contents to the driver on the basis of the risk degree related to the subject vehicle, and enable the driver to easily recognize the risk degree.

The warning control device (10) of the second aspect may be implemented in combination with the first aspect. In the second aspect, when the second determination results in that the vehicle is attempting an overtaking action while a lane to be used for the overtaking action is an opposite lane, the hardware processor determines, as a result of the third determination, that the risk degree is higher than a risk degree in a situation where a lane to be used for an overtaking action is not an opposite lane. According to the second aspect, it is possible to enable the driver to easily recognize the increase of the risk degree resulted by the use of the opposite lane for overtaking by the subject vehicle.

The warning control device (10) of the third aspect may be implemented in combination with the first or the second aspect. In the third aspect, the hardware processor is further configured to determine (S14) whether an oncoming vehicle travelling in an opposite direction of an advancing direction of the vehicle exists within a given distance from the vehicle, and, in response to determining that the oncoming vehicle exists within the given distance, the hardware processor determines, as a result of the third determination, that the risk degree is higher than a risk degree in a situation where the oncoming vehicle does not exist within the given distance. According to the third aspect, it is possible to enable the driver to recognize the increase of the risk degree resulted by the existence of the oncoming vehicle within a given distance from the subject vehicle.

The warning control device (10) of the fourth aspect may be implemented in combination with any one of the first to the third aspects. In the fourth aspect, the warning device is a device to display an image, and the hardware processor controls the contents of warning by outputting, to the warning device, a signal for changing an image representing warning indication displayed by the warning device. According to the fourth aspect, it is possible to enable the driver to recognize the risk degree through the driver's visual sense.

The warning control device (10) of the fifth aspect may be implemented in combination with the fourth aspect. In the fifth aspect, the signal for changing the image is a signal for changing a color of at least part of the warning indication. According to the fifth aspect, it is possible to enable the driver to recognize the risk degree through the driver's visual sense.

The warning control device (10) of the sixth aspect may be implemented in combination with the fourth or the fifth aspect. In the sixth aspect, the signal for changing the image is a signal for changing a color of a division line included in the warning indication. According to the sixth aspect, it is possible to enable the driver to easily recognize the risk degree resulted by overtaking by the subject vehicle.

The warning control device (10) of the seventh aspect may be implemented in combination with any one of the fourth to the sixth aspects. In the seventh aspect, the signal for changing the image is a signal for changing a size of at least part of the warning indication. According to the seventh aspect, it is possible to enable the driver to recognize the risk degree through the driver's visual sense.

The warning control device (10) of the eighth aspect may be implemented in combination with any one of the fourth to the seventh aspects. In the eighth aspect, the signal for changing the image is a signal for changing the warning indication by an animation. According to the eighth aspect, it is possible to enable the driver to recognize the risk degree through the driver's visual sense.

The warning control device (10) of the ninth aspect may be implemented in combination with any one of the first to the eighth aspects. In the ninth aspect, the warning device is a device to output sound, and the hardware processor controls the contents of warning by outputting, to the warning device, a signal for changing sound to be output from the warning device. According to the ninth aspect, it is possible to enable the driver to recognize the risk degree through the driver's auditory sense.

The warning control device (10) of the tenth aspect may be implemented in combination with any one of the first to the ninth aspects. In the tenth aspect, the warning device is a device to generate vibration, and the hardware processor controls the contents of warning by outputting, to the warning device, a signal for changing vibration to be generated by the warning device. According to the tenth aspect, it is possible to enable the driver to recognize the risk degree through the driver's tactile sense.

The warning control device (10) of the eleventh aspect may be implemented in combination with any one of the first to the tenth aspects. In the eleventh aspect, the warning device is a device to emit light, and the hardware processor controls the contents of warning by outputting, to the warning device, a signal for changing light to be emitted from the warning device. According to the eleventh aspect, it is possible to enable the driver to recognize the risk degree through the driver's visual sense.

The warning control method of the twelfth aspect is implemented by a computer provided in a vehicle. The method includes: executing a first determination (Si) to determine whether the vehicle is traveling in an overtaking prohibited section; executing a second determination (S2) to determine whether the vehicle is attempting an overtaking action; executing a third determination (S3-S5) to determine a risk degree of the vehicle on a basis of a result of the first determination and a result of the second determination; and outputting (S6), to a warning device issuing warning to a driver of the vehicle, a signal for controlling contents of warning to be issued by the warning device, the signal being based on a result of the third determination. According to the twelfth aspect, it is possible to change the warning contents to the driver on the basis of the risk degree related to the subject vehicle, and enable the driver to easily recognize the risk degree.

The computer program product of the thirteenth aspect includes a non-transitory computer-readable recording medium on which an executable program is recorded. The program instructs a computer provided in a vehicle to: execute a first determination (S1) to determine whether the vehicle is traveling in an overtaking prohibited section; execute a second determination (S2) to determine whether the vehicle is attempting an overtaking action; execute a third determination (S3-S5) to determine a risk degree of the vehicle on a basis of a result of the first determination and a result of the second determination; and output (S6), to a warning device issuing warning to a driver of the vehicle, a signal for controlling contents of warning to be issued by the warning device, the signal being based on a result of the third determination. According to the thirteenth aspect, it is possible to change the warning contents to the driver on the basis of the risk degree related to the subject vehicle, and enable the driver to easily recognize the risk degree.

The present disclosure is capable of bringing an advantage of enabling the driver to easily recognize the risk degree of the subject vehicle.

What is claimed is:

1. A warning control device comprising:
a hardware processor connected to a warning device issuing warning to a driver of a vehicle in which the warning control device is provided, the hardware processor being configured to:
execute a first determination to determine whether the vehicle is traveling in an overtaking prohibited section;
execute a second determination to determine whether the vehicle is attempting an overtaking action;
execute a third determination to determine a risk degree of the vehicle on a basis of a result of the first determination and a result of the second determination; and
output, to the warning device, a signal for controlling contents of warning to be issued by the warning device, the signal being based on a result of the third determination.

2. The warning control device according to claim 1, wherein, when the second determination results in that the vehicle is attempting an overtaking action while a lane to be used for the overtaking action is an opposite lane, the hardware processor determines, as a result of the third determination, that the risk degree is higher than a risk degree in a situation where a lane to be used for an overtaking action is not an opposite lane.

3. The warning control device according to claim 1, wherein
the hardware processor is further configured to determine whether an oncoming vehicle travelling in an opposite direction of an advancing direction of the vehicle exists within a given distance from the vehicle, and,
in response to determining that the oncoming vehicle exists within the given distance, the hardware processor determines, as a result of the third determination, that the risk degree is higher than a risk degree in a situation where the oncoming vehicle does not exist within the given distance.

4. The warning control device according to claim 1, wherein
the warning device is a device to display an image, and
the hardware processor controls the contents of warning by outputting, to the warning device, a signal for changing an image representing warning indication displayed by the warning device.

5. The warning control device according to claim 4, wherein the signal for changing the image is a signal for changing a color of at least part of the warning indication.

6. The warning control device according to claim 4, wherein the signal for changing the image is a signal for changing a color of a division line included in the warning indication.

7. The warning control device according to claim 4, wherein the signal for changing the image is a signal for changing a size of at least part of the warning indication.

8. The warning control device according to claim 4, wherein the signal for changing the image is a signal for changing the warning indication by an animation.

9. The warning control device according to claim 1, wherein
the warning device is a device to output sound, and
the hardware processor controls the contents of warning by outputting, to the warning device, a signal for changing sound to be output from the warning device.

10. The warning control device according to claim 1, wherein
the warning device is a device to generate vibration, and
the hardware processor controls the contents of warning by outputting, to the warning device, a signal for changing vibration to be generated by the warning device.

11. The warning control device according to claim 1, wherein
the warning device is a device to emit light, and
the hardware processor controls the contents of warning by outputting, to the warning device, a signal for changing light to be emitted from the warning device.

12. A warning control method implemented by a computer provided in a vehicle, the method comprising:
executing a first determination to determine whether the vehicle is traveling in an overtaking prohibited section;
executing a second determination to determine whether the vehicle is attempting an overtaking action;
executing a third determination to determine a risk degree of the vehicle on a basis of a result of the first determination and a result of the second determination; and
outputting, to a warning device issuing warning to a driver of the vehicle, a signal for controlling contents of warning to be issued by the warning device, the signal being based on a result of the third determination.

13. A computer program product comprising a non-transitory computer-readable recording medium on which an executable program is recorded, the program instructing a computer provided in a vehicle to:
execute a first determination to determine whether the vehicle is traveling in an overtaking prohibited section;
execute a second determination to determine whether the vehicle is attempting an overtaking action;
execute a third determination to determine a risk degree of the vehicle on a basis of a result of the first determination and a result of the second determination; and
output, to a warning device issuing warning to a driver of the vehicle, a signal for controlling contents of warning to be issued by the warning device, the signal being based on a result of the third determination.
